(19) United States
(12) Patent Application Publication
(10) Pub. No.: US 2005/0184101 A1
(43) Pub. Date: Aug. 25, 2005

(54) Fluid-storing and -dispensing container

(76) Inventor: Masatoshi Masuda, Kyoto-city (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/061,061

(22) Filed: Feb. 18, 2005

(30) Foreign Application Priority Data
Feb. 20, 2004 (JP) 2004-043842

(51) Int. Cl. B67D 5/40

(52) U.S. Cl. 222/380

(57) ABSTRACT

A fluid-storing and -dispensing container includes a tubular fluid-storing portion 10; a piston 20 capable of traveling inside the fluid-storing portion 10 in the axial direction; an inflow valve mechanism 30 provided at the bottom of the fluid-storing portion 10 and enabling outer-air to flow into the fluid-storing portion 10; and an outflow valve mechanism 40 provided in an opening portion of the fluid-storing portion 10 and enabling a fluid to flow out from the fluid-storing portion 10.

### BACKGROUND OF THE INVENTION

1. Field of the Invention

The present invention generally relates to a fluid-storing and -dispensing container which liquidtightly stores a fluid therein and discharges the fluid stored when compressed from the outside.

2. Description of the Related Art

Hitherto, as such fluid-storing containers, fluid-storing containers which improve their operability by preserving their external shape regardless of a fluid amount stored inside them are known. For example, the container described in Japanese Patent Laid-open No. 2000-109103 comprises two layers comprising an inner layer in which a fluid is stored and an outer layer surrounding the outside of the inner layer. In this outer layer, a valve mechanism for letting outer-air flow into a space formed between the outer layer and the inner layer is provided. With this configuration provided, even when a capacity of the inner layer reduces as a fluid stored inside the inner layer has flowed out, outer-air flows into the space formed between the outer layer and the inner layer from the valve mechanism, thereby making it possible to preserve the external shape of the container.

In this container described in Japanese Patent Laid-open No. 2000-109103, in order to deform the inner layer according to a decreased amount of fluid stored in the container, using a material lacking in elastic resilience for the inner layer is preferable. However, if this inner layer lacking elastic resilience is adopted, the inner layer cannot be used repeatedly. Additionally, because the container described in Japanese Patent Laid-open No. 2000-109103 has a double-layered structure comprising the inner layer and the outer layer, it is unavoidable that the configuration becomes complex and its assembly becomes complicated.

### SUMMARY OF THE INVENTION

Consequently, in an aspect, an object of the present invention is to provide a fluid-storing and -dispensing container usable repeatedly as well as capable of storing a fluid liquidtightly.

The present invention can be practiced in various ways including, but not limited to, embodiments described below, wherein numerals used in the drawings are used solely for the purpose of ease in understanding of the embodiments which should not be limited to the numerals. Further, in the present specification, different terms or names may be assigned to the same element, and in that case, one of the different terms or names may functionally or structurally overlap or include the other or be used interchangeably with the other.

In an embodiment, the present invention provides a fluid-storing and -dispensing container comprising: (a) a tubular fluid-storing portion (e.g., 10) which is compressible and shape-restorable; (b) an inflow valve mechanism (e.g., 32, 50) provided at a lower end of the fluid-storing portion, said inflow valve mechanism being a one-way valve permitting outer-air to flow therethrough into the fluid-storing portion; (c) an outflow valve mechanism (e.g., 40, 60) provided at an upper end of the fluid-storing portion, said outflow valve mechanism being a one-way valve for dispensing therethrough a fluid stored in the fluid-storing portion; and (d) a piston (e.g., 20) capable of moving inside the fluid-storing portion in its axial direction between the lower end the upper end, said piston constituting a bottom of the tubular flexible fluid-storing portion, wherein the fluid is stored in the fluid-storing portion between the piston and the upper end and dispensed through the outflow valve mechanism when the fluid-storing portion is compressed inward.

The above embodiment further includes, but is not limited to, the following embodiments:

The piston may comprise an upper liquidtight portion (e.g., 21), a lower liquidtight portion (e.g., 21′), and a narrowed portion (e.g., 22) between the upper and lower liquidtight portions.

A neck portion (e.g., 200) may be provided at the upper end of the fluid-storing portion, and the outflow valve mechanism may be attached to the neck portion.

The outflow valve mechanism (e.g., 40, 60) may comprise: an outflow valve member (e.g., 41, 61) and an outflow valve seat member (e.g., 42, 62), which are co-axially provided.

The outflow valve member (e.g., 40) may comprise a flexible valve body portion (e.g., 411) extending radically from a central portion (e.g., 440), wherein the flexible valve body portion has a peripheral edge (e.g., 441) which is in contact with an inner surface portion (e.g., 421) of the outflow valve seat member to close the outflow valve mechanism and which is apart from the inner surface portion of the outflow valve seat member to open the outflow valve mechanism when the fluid stored in the fluid-storing portion is pressurized.

The outflow valve member may further comprise a supporting portion (e.g., 412) extending downward from the central portion, and the outflow valve mechanism may further comprise a supporting member (e.g., 43) which supports the supporting portion of the outflow valve member and which is attached to the neck portion.

The supporting portion may be a first supporting portion (e.g., 412), and the outflow valve member may further comprise a second supporting portion (e.g., 413) extending upward from the central portion.

The outflow valve seat member may comprise (i) an opening portion (e.g., 423) through which the fluid is dispensed, said opening portion being provided above the inner surface portion (e.g., 421); (ii) multiple ribs (e.g., 424) formed inside the opening portion and supporting the second supporting portion; and (iii) an engaging portion (e.g., 422) which engages with the neck portion and secures the supporting member to the neck portion.

The supporting member (e.g., 43) may comprise multiple ribs (e.g., 432) supporting the first supporting portion of the outflow valve member, wherein spaces (e.g., 433) between the multiple ribs constitute a fluid path through which the fluid passes.

The first supporting portion (e.g., 412) may be movable in its axial direction in the ribs (e.g., 432) of the supporting member, and the second supporting portion (e.g., 413) may be movable in its axial direction in the ribs (e.g., 424) of the outflow valve seat member.

The outflow valve member (e.g., 60) may comprise: (a) a valve body portion (e.g., 611); (b) a supporting portion (e.g., 612) for supporting the valve body portion, which is coupled to the outflow valve seat member (e.g., 62); and (c) a flexible connecting portion (e.g., 613) connecting the valve body portion and the supporting portion.

The flexible connecting portion (e.g., 613) may be constituted by multiple connecters (e.g., 613) attached to a peripheral edge of the valve body portion.

The outflow valve seat member (e.g., 62) may comprise (i) an opening portion (e.g., 622) which is closed when the valve body portion (e.g., 611) is in contact with the opening portion and which is open when the valve body portion moves away from the opening portion as the fluid stored in the fluid-storing portion is pressurized and passes through the opening portion; and (ii) an engaging portion (e.g., 624) which engages with the neck portion.

The fluid-storing and -dispensing container may further comprise a nozzle member (e.g., 630) which engages with the neck portion and secures the engaging portion of the outflow valve seat member.

The inflow valve mechanism (e.g., 30) may comprise: an inflow valve member (e.g., 31) and an inflow valve seat member (e.g., 32), which are co-axially provided.

The inflow valve member (e.g., 31) may comprise: (a) a valve body portion (e.g., 312); (b) a supporting portion (e.g., 311) for supporting the valve body portion, which is coupled to the inflow valve seat member (e.g., 32); and (c) a flexible connecting portion (e.g., 313) connecting the valve body portion (e.g., 312) and the supporting portion (e.g., 311).

The flexible connecting portion (e.g., 313) may be constituted by multiple connecters (e.g., 313) attached to a peripheral edge of the valve body portion (e.g., 312).

The inflow valve seat member (e.g., 32) may comprise (i) an opening portion (e.g., 322) which is closed when the valve body portion (e.g., 312) is in contact with the opening portion and which is open when the valve body portion moves away from the opening portion as a pressure between the piston and the inflow valve mechanism is lower than the outside, whereby outer-air passes through the opening portion; (ii) an engaging portion (e.g., 322) which engages with the supporting portion (e.g., 311) of the inflow valve member; and (iii) a bottom portion (e.g., 11) with a jointed portion (e.g., 111), wherein the opening portion is formed in the bottom portion, and the jointed portion is jointed to the lower end of the fluid-storing portion.

The inflow valve member (e.g., 51) may comprise (i) a flexible valve body portion (e.g., 511) extending radically from a central portion (e.g., 531), wherein the flexible valve body portion has a peripheral edge which is in contact with an inner surface portion (e.g., 522) of the inflow valve seat member to close the inflow valve mechanism and which is apart from the inner surface portion of the inflow valve seat member to open the inflow valve mechanism when a pressure between the piston and the inflow valve mechanism is lower than the outside, whereby outer-air passes through the inflow valve mechanism; and (ii) a supporting member (e.g., 512) which extends downward from the central portion, said supporting member being attached to the inflow valve seat mechanism.

The inflow valve seat member (e.g., 52) may comprise (i) a valve member supporting portion (e.g., 521) to which the supporting member (e.g., 512) of the inflow valve member is attached; (ii) an opening portion (e.g., 523) through which outer-air passes, said opening portion being formed around the valve member supporting portion (e.g., 521) and being surrounded by the inner surface portion (e.g., 522); and (iii) a bottom portion (e.g., 14) with a jointed portion (e.g., 141), wherein the opening portion is formed in the bottom portion, and the jointed portion is jointed to the lower end of the fluid-storing portion.

The fluid-storing and -dispensing container may be reusable wherein the outflow valve mechanism is detachably provided at the upper end of the fluid-storing portion, and after the fluid is dispensed, the fluid-storing portion is refilled with another fluid through the upper end of the fluid-storing portion.

In all of the aforesaid embodiments, any element used in an embodiment can interchangeably be used in another embodiment unless such a replacement is not feasible or causes adverse effect. Further, the present invention can equally be applied to apparatuses and methods.

For purposes of summarizing the invention and the advantages achieved over the related art, certain objects and advantages of the invention have been described above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention. The drawings are oversimplified for illustrative purposes.

FIG. 1 is a lateral cross section of the fluid-storing container according to Embodiment 1 of the present invention.

FIGS. 2(a), 2(b), and 2(c) are explanatory views showing the outflow valve member 41 comprising the outflow valve mechanism 40.

FIGS. 3(a), 3(b), and 3(c) are explanatory views showing the supporting member 43 comprising the outflow valve mechanism 40.

FIGS. 4(a), 4(b), and 4(c) are explanatory views showing the outflow valve seat member 42 comprising the outflow valve mechanism 40.

FIGS. 5(a), 5(b), and 5(c) are explanatory views showing the inflow valve member 31 comprising the inflow valve mechanism 30 according to Embodiment 1 of the present invention.

FIGS. 6(a), 6(b), and 6(c) are explanatory views showing the bottom portion 11 of the fluid-storing portion 10, which is formed as one with the inflow valve seat member 32 comprising the inflow valve mechanism 30 according to Embodiment 1 of the present invention.

FIG. 7 is an explanatory view showing how inside the fluid-storing portion 10 in the fluid-storing container according to Embodiment 1 of the present invention functions when the fluid-storing portion 10 is pressed.

FIG. 8 is an explanatory view showing how inside the fluid-storing portion 10 in the fluid-storing container according to Embodiment 1 of the present invention functions when the pressure applied to the fluid-storing portion 10 is removed.

FIG. 9 is an explanatory view showing how inside the fluid-storing portion 10 in the fluid-storing container according to Embodiment 2 of the present invention functions when the fluid-storing portion 10 is pressed.

FIG. 10 is an explanatory view showing how inside the fluid-storing portion 10 in the fluid-storing container according to Embodiment 2 of the present invention functions when the pressure applied to the fluid-storing portion 10 is removed.

FIGS. 11(a), 11(b), 11(c), and 11(d) are explanatory views showing an inflow valve member 51 comprising the inflow valve mechanism 50 according to Embodiment 2 of the present invention.

FIGS. 12(a), 12(b), and 12(c) are explanatory views showing a bottom portion 14 of a fluid-storing portion 10, which is formed as one with an inflow valve seat member 52 comprising the inflow valve mechanism 50 according to Embodiment 2 of the present invention.

FIG. 13 is a lateral cross section of the fluid-storing container according to Embodiment 3 of the present invention.

Explanation of symbols used in the drawings are as follows: 1: Cap; 10: Fluid-storing portion; 11: Bottom portion; 12: Cylinder portion; 13: Opening portion; 14: Bottom portion; 20: Piston; 21: Liquidtight portion; 22: Narrowed portion; 30: Inflow valve mechanism; 31: Inflow valve member; 32: Inflow valve seat member; 40: Outflow valve mechanism; 41: Outflow valve member; 42: Outflow valve seat member; 43: Supporting member; 50: Inflow valve mechanism; 51: Inflow valve member; 52: Inflow valve seat member; 60: Outflow valve mechanism; 61: Outflow valve member; 62: Outflow valve seat member; 111: Joined portion; 121: Lower end; 141: Joined portion; 311: Supporting portion; 312: Valve body portion; 313: Coupling portion; 314: Flexion; 321: Engaging portion; 322: Opening portion; 411: Valve body portion; 412: First supporting portion; 413: Second supporting portion; 421: Valve seat portion; 422: Engaging portion; 423: Opening portion; 424: Rib; 431: Engaging portion; 432: Rib; 433: Flow path; 511: Valve body portion; 512: Supporting portion; 521: Valve member supporting portion; 522: Valve seat portion; 523: Opening portion; 611: Valve body portion; 612: Supporting portion; 613: Coupling portion; 621: Valve seat portion; 622: Opening portion; 623: Joined portion; 624: Engaging portion.

### DETAILED DESCRIPTION OF THE PREFERRED EMBODIMENT

The present invention will be explained with respect to preferred embodiments. However, the present invention is not limited to the preferred embodiments.

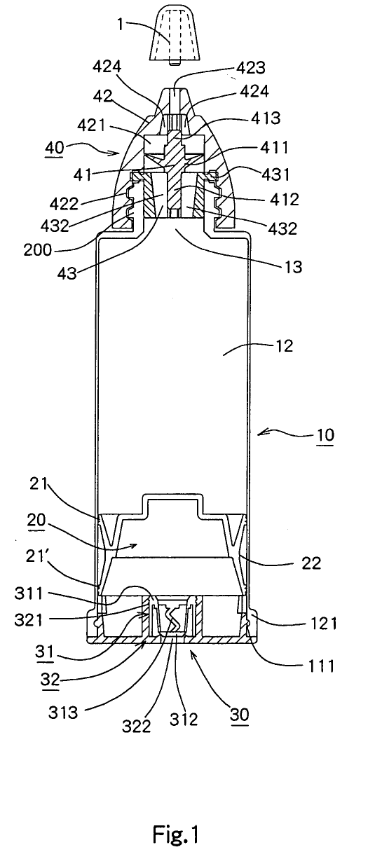

Embodiment 1 of the present invention is described in detail below with reference to drawings attached. FIG. 1 is a lateral cross section of the fluid-storing container according to Embodiment 1 of the present invention.

This fluid-storing container is used as a container for beauty products for storing gels such as hair gels and cleansing gels, creams such as nourishing creams and cold creams or liquids such as skin lotions used in the cosmetic field. Additionally, this fluid-storing container also can be used as a container for medicines, solvents or foods, etc.

In this specification, high-viscosity liquids, semifluids, gels that sol solidifies to a jelly, and creams and regular liquids are all referred to as fluids. However, the present invention is not limited to the above-mentioned container intended to be used with liquids, but can be applied to fluid-storing containers intended to be used with fluids including gases.

The fluid-storing container according to Embodiment 1 of the present invention comprises a tubular flexible fluid-storing portion 10 with a bottom, inside which functions as a cylinder, a piston 20 capable of traveling inside the fluid-storing portion 10 in the axial direction of the cylinder, an inflow valve mechanism 30 being provided at the bottom of the fluid-storing portion 10 and enabling outer-air to flow into the fluid-storing portion 10 from the outside, an outflow valve mechanism 40 being provided in an opening portion of the fluid-storing portion 10 and enabling a fluid to flow out from the fluid-storing portion 10 to the outside, and a cap 1 for closing the discharge opening of the fluid-storing container. Additionally, in this specification, for the sake of convenience, the side of the outflow valve mechanism 40 in the fluid-storing container is defined as upward, and the side of the inflow valve mechanism 30 is defined as downward.

The fluid-storing portion 10 comprises a bottom portion 11, a cylinder portion 12, and an opening portion 13 for fluid outflow being formed over the cylinder portion 12.

The bottom portion 11 comprises a joined portion 111 being joined with a lower end 121 of the cylinder portion 12. The bottom portion 11 also comprises an engaging portion 321 for supporting an inflow valve member 31 in the inflow valve mechanism 30 described in detail later and is formed as one with an inflow valve seat member 32 in the center of which an opening portion 322 for letting outer-air flow into the inflow valve mechanism 30 is formed. Additionally, the joined portion 11 in the bottom portion 11 and the lower end 121 in the cylinder portion 12 are liquidtightly joined together, for example, by ultrasonic welding, etc. By this, it becomes possible to prevent fluid leakage from between the bottom portion 11 and the cylinder portion 12. Additionally, ultrasonic welding is to be achieved that atoms in the portions to be joined together of respective members are diffused by giving high frequency vibrations to the joined portions, and are recrystallized again.

In the upper and lower portions of the piston 20, liquidtight portions 21 contacting the inside of the fluid-storing portion 10 are formed. In this piston 20, a pair of liquidtight portions 21 disposed being apart from each other only by a fixed distance is formed. Therefore, regardless of a direction of stress applied to the piston 20, the center of axle of the piston 20 and the center of axle of the cylinder portion 12 in the fluid-storing portion 10 can always be brought in line. By this, it becomes possible to let the piston 20 travel smoothly in the cylinder portion 12.

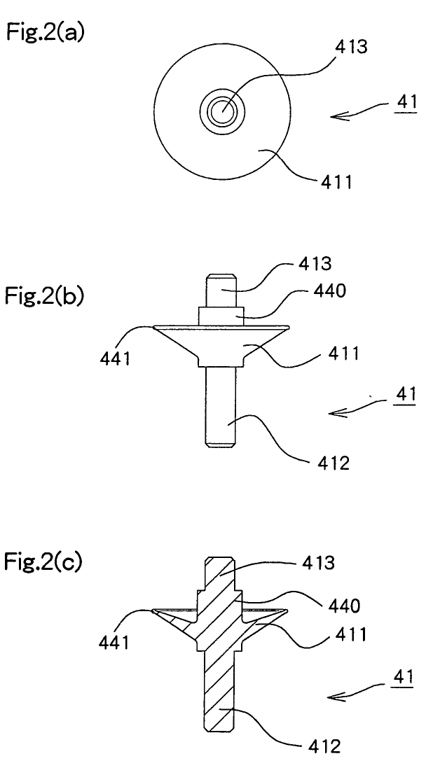

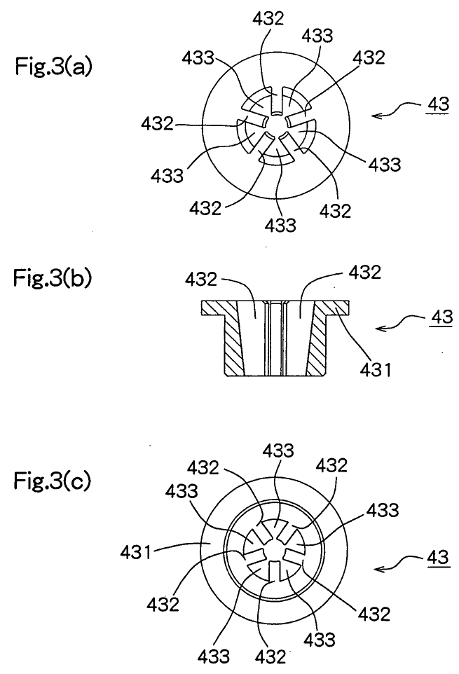

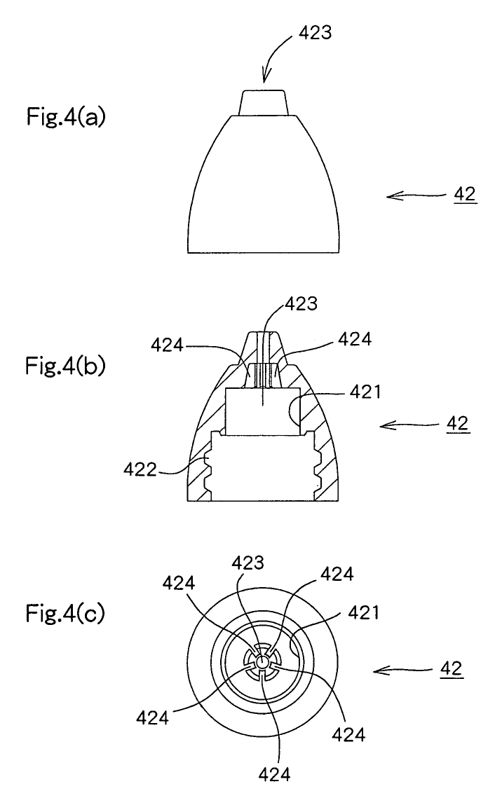

FIGS. 2(a)-(c) are explanatory views showing the outflow valve member 41 comprising the outflow valve mechanism 40; FIGS. 3(a)-(c) are explanatory views showing a supporting member 43 comprising the outflow valve mechanism 40; FIGS. 4(a)-(c) are explanatory views showing an outflow valve seat member 42 comprising the outflow valve mechanism 40. Additionally, FIGS. 2(a)-(c) are a plan view, lateral view, and lateral cross section, respectively, showing the outflow valve member 41; FIGS. 3(a)-(c) are a plan view, lateral cross section and bottom view, respectively, showing the supporting member 43; FIGS. 4(a)-(c) are a lateral view, lateral cross section and bottom view, respectively, showing the outflow valve seat member 42.

The outflow valve mechanism 40 comprises the outflow valve member 41 possessing a valve body portion 411, the supporting portion 43 supporting the outflow valve member 41, and the outflow valve seat member 42 possessing a valve seat portion 421 having a shape corresponding to the valve body portion 411 in the outflow valve member 41.

The outflow valve member 41 comprises the flexible valve body portion 411 radiating from the central portion, a first supporting portion 412 extending from the central portion of the valve body portion 411, and a second supporting portion 413 extending from the central portion of the valve body portion 411 and being provided on the opposite side of the first supporting portion 412.

The supporting member 43 comprises an engaging portion 431 engaging with the opening portion 13 in the fluid-storing portion 10, five ribs 432 supporting the first supporting portion 412 in the outflow valve member 41, and flow paths 433 being formed between adjacent ribs 432.

Additionally, the flow paths are formed so as to enable a fluid to pass through between inside and outside the fluid-storing portion 10.

Although the supporting member 43 is adapted to comprise five ribs 432, the number of ribs is not limited to five. However, in order to effectively prevent inadequate inclination of the outflow valve member 41, it is preferable to provide three or more ribs 432 (e.g., an integer of 3-20); it is more preferable to dispose those ribs 432 at equal circumferential intervals.

The outflow valve seat member 42 comprises the valve seat portion 421 having a shape corresponding to an edge portion of the valve body portion 411 in the outflow valve member 41, an engaging portion 422 engaging with the opening portion 13 in the fluid-storing portion 10, an opening portion 423 through which a fluid can pass through between inside and outside the fluid-storing portion 10, and five ribs 424 being formed inside the opening portion 423 and supporting the second supporting portion 413 in the outflow valve member 41.

Although the outflow valve seat member 42 is adapted to comprise five ribs 424, the number of ribs is not limited to five. However, in order to effectively prevent inadequate inclination of the outflow valve member 41, it is preferable to provide three or more ribs 424 (e.g., an integer of 3-20); it is more preferable to dispose those ribs 424 at equal circumferential intervals.

The first supporting portion 412 is movably supported relative to the ribs 432 in the supporting member 43; the second supporting portion 413 is movably supported relative to the ribs 424 in the outflow valve seat member 42. Therefore, it becomes possible to bring a fluid having flowed out in the vicinity of a discharge opening back in and to suppress fluid accumulation in the vicinity of the discharge opening.

When this outflow valve mechanism 40 comprising the outflow valve member 41, the outflow valve seat member 42 and the supporting member 43 is compressed from downward, the edge portion of the valve body portion 411 travels to a position in which it separates from the valve seat portion 421 in the outflow valve seat member 42 from a position in which it contacts the valve seat portion 421 by the flexibility of the valve body portion 411 in the outflow valve member 41. This enables a fluid to pass through the outflow valve mechanism 40. When the compression to the outflow valve mechanism 40 from downward is removed, the edge portion of the valve body portion 411 travels to the position in which it contacts the valve seat portion 421 in the outflow valve seat member 42 from the position in which it separates from the valve seat portion 421 by the flexibility of the valve body portion 411 in the outflow valve member 41. This makes the fluid impossible to pass through the outflow valve mechanism 40.

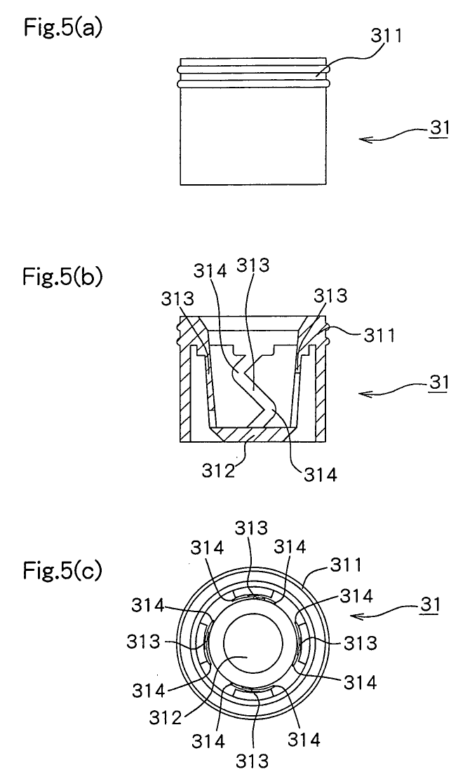

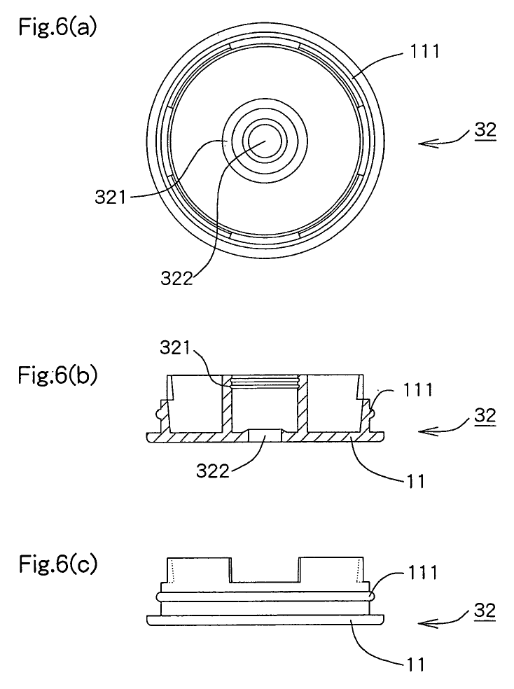

FIGS. 5(a)-(c) are explanatory views showing the inflow valve member 31 comprising the inflow valve mechanism 30 according to Embodiment 1 of the present invention; FIGS. 6(a)-(c) are explanatory views showing the bottom portion 11 of the fluid-storing portion 10, which is formed as one with the inflow valve seat member 32 comprising the inflow valve mechanism 30 according to Embodiment 1 of the present invention. FIGS. 5(a)-(c) are a lateral view, lateral cross section and bottom view, respectively, showing the inflow valve member 31; FIGS. 6(a)-(c) are a plan view, lateral cross section and lateral view, respectively, showing the bottom portion 11.

The inflow valve mechanism 30 comprises the bottom portion 11 being formed as one with the nearly-tubular inflow valve seat member 32 in which the opening portion 322 for fluid inflow is formed, and the inflow valve member 31 disposed inside the inflow valve seat member 32.

The inflow valve member 31 comprises an annular supporting portion 311, a valve body portion 312 having a shape corresponding to the opening portion 322 of the inflow valve seat member 32, and four flexible coupling portions 313 coupling the supporting portion 311 and the valve body portion 312. These respective coupling portions 313 have a pair of flexions. Therefore, the respective coupling portions 313 have adequate elastic force, thereby enabling to let the valve body portion 312 travel smoothly.

Although the inflow valve member 31 is adapted to comprise four coupling portions 313, the number of coupling portions is not limited to four. However, in order to effectively prevent inadequate inclination of the inflow valve member 31, it is preferable to provide three or more coupling portions (e.g., an integer of 3-10); it is more preferable to provide those coupling portions at equal circumferential intervals. Additionally, it is preferable to set a thickness of the coupling portion at about 1 mm or less; it is more preferable to set it at about 0.3 mm to about 0.5 mm.

The inflow valve seat member 32 being formed as one with the bottom portion 11 comprises the engaging portion 321 engaging with the supporting portion 311 for supporting the inflow valve member 31, in the center of which the circular opening portion 322 is formed.

Additionally, the bottom portion 11 comprises the joined portion 111 being joined with the lower end 121 of the fluid-storing portion 10.

When the inflow valve mechanism 30 comprising the inflow valve member 31 and the inflow valve seat member 32 is compressed from downward, the valve body portion 312 travels from a position in which it closes the opening portion 322 in the inflow valve seat member 32 to a position in which it opens the opening portion 322 by the flexibility of the coupling portions 313 in the inflow valve member 31. This enables outer-air to pass through the inflow valve mechanism 30. When upward and downward pressures being applied to the inflow valve mechanism 30 become approximately equal by outer-air having flowed in, the valve body portion 312 travels to a position in which it closes the opening portion 322 in the inflow valve seat member 32 from a position in which it opens the opening portion 322 by the flexibility of the coupling portion 313 in the inflow valve member 31. This makes outer-air impossible to pass through the inflow valve mechanism 30.

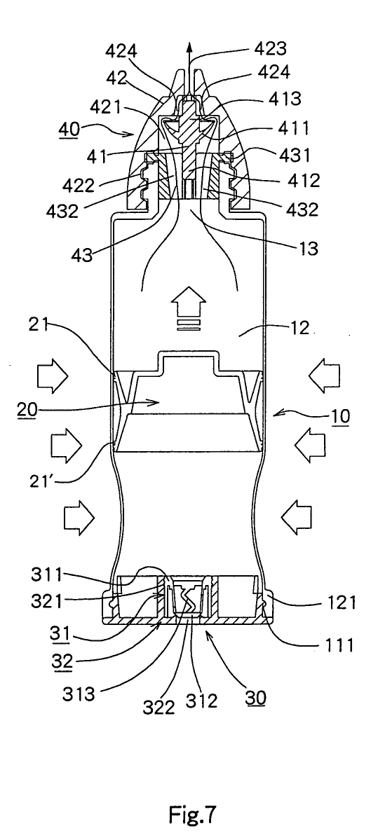

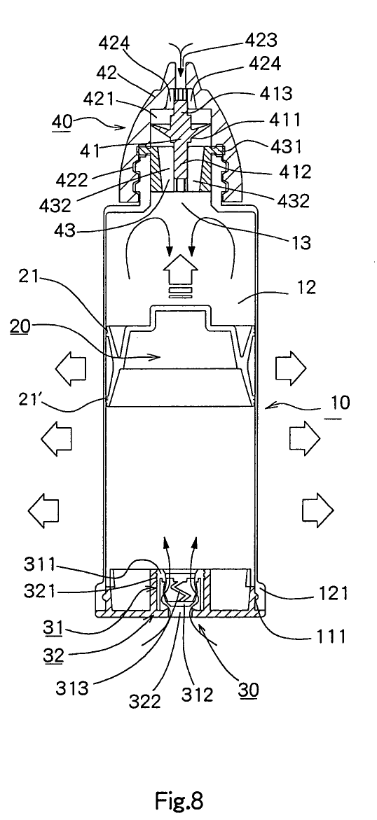

FIG. 7 is an explanatory view showing how inside the fluid-storing portion 10 in the fluid-storing container according to Embodiment 1 of the present invention functions when it is pressed from the outside. FIG. 8 is an explanatory view showing how inside the fluid-storing portion 10 in the fluid-storing container according to Embodiment 1 of the present invention functions when the pressure applied to it is removed.

As shown in FIG. 7, when inside the fluid-storing portion 10 is pressurized, a fluid stored inside it and the outflow valve mechanism 40 are compressed from downward. When the outflow valve mechanism 40 is compressed from downward, the edge portion of the valve body portion 411 travels to a position in which it separates from the valve seat portion 421 in the outflow valve seat member 42 from a position in which it contacts the valve seat portion 421 by the flexibility of the valve body portion 411 in the outflow valve member 41. By this, the fluid passes through the outflow valve mechanism 40 and then flows outside the fluid-storing container. Additionally, at this time, the outflow valve member 41 travels upward relative to the outflow valve seat member 42 and the supporting member 43.

As an amount of the fluid reduces with the fluid having flowed out, the piston 20 ascends inside the cylinder portion 12; and the lower portion side of the fluid-storing portion 10 being partitioned by the piston 20 is depressurized. Consequently, the inflow valve mechanism 30 is compressed from downward. When the inflow valve mechanism 30 is compressed from downward, the valve body portion 312 travels to a position in which it opens the opening portion 322 in the inflow valve seat member 32 from a position in which it closes the opening portion 322 by the flexibility of the coupling portions 313 in the inflow valve member 31. By this, outer-air passes through the inflow valve mechanism 30 and then flows into the fluid-storing portion of the container.

When the pressure applied to the fluid-storing portion 10 is removed and the compression to the outflow valve mechanism 40 from downward is removed, the edge portion of the valve body portion 411 travels to a position in which it contacts the valve seat portion 421 in the outflow valve seat member 42 from a position in which it separates from the valve seat portion 421 by the flexibility of the valve body portion 411 in the outflow valve member 41. This makes the fluid impossible to pass through the outflow valve mechanism 40. At this time, the outflow valve member 41 having traveled upward when compressed previously travels downward relative to the outflow valve seat member 42 and the supporting member 43. By this, it becomes possible to bring a fluid having flowed out in the vicinity of the discharge opening back in as the outflow valve member 41 travels, thereby enabling to suppress fluid accumulation in the vicinity of the discharge opening.

When upward and downward pressures being applied to the inflow valve mechanism 30 become approximately equal by outer-air having flowed in, the valve body portion 312 travels to a position in which it closes the opening portion 322 in the inflow valve seat member 32 from a position in which it opens the opening portion 322 by the flexibility of the coupling portion 313 in the inflow valve member 31. This makes outer-air impossible to pass through the inflow valve mechanism 30.

The fluid-storing container according to Embodiment 2 of the present invention is described in detail below with reference to drawings attached.

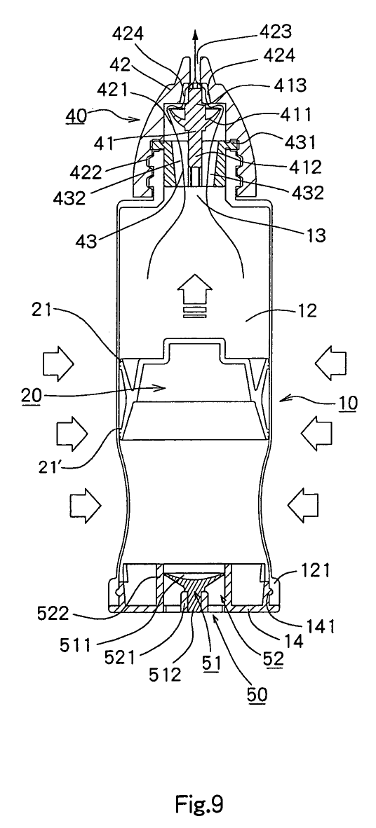

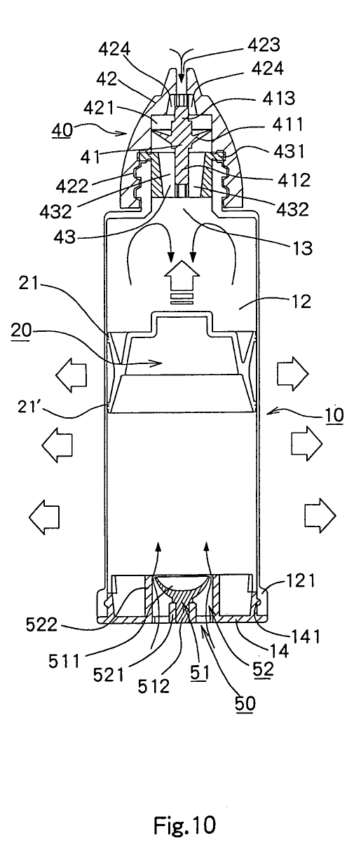

FIG. 9 is an explanatory view showing how inside the fluid-storing portion 10 in the fluid-storing container according to Embodiment 2 of the present invention functions when it is pressed from the outside. FIG. 10 is an explanatory view showing how inside the fluid-storing portion 10 in the fluid-storing container according to Embodiment 1 of the present invention functions when the pressure applied to it is removed. Additionally, when the same members as used in Embodiment 1 are used in Embodiment 2, the same symbols are used and detailed descriptions of the members are omitted.

Whereas the fluid-storing container according to Embodiment 1 comprises the inflow valve mechanism 30, the fluid-storing container according to Embodiment 2 comprises an inflow valve mechanism 50 in place of the inflow valve mechanism 30.

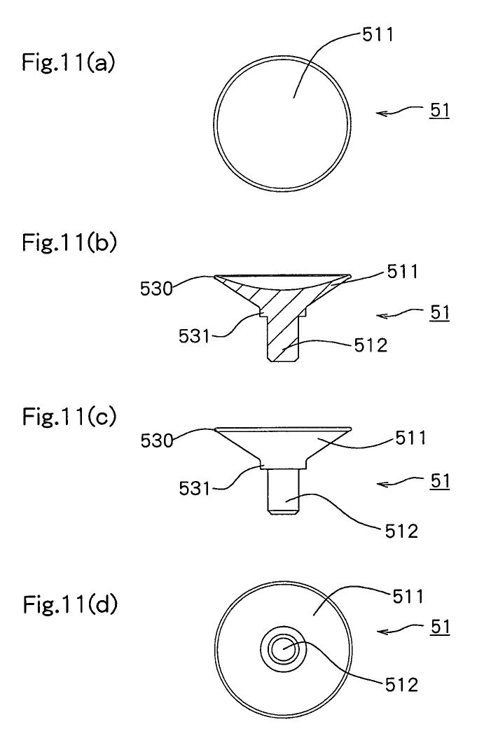

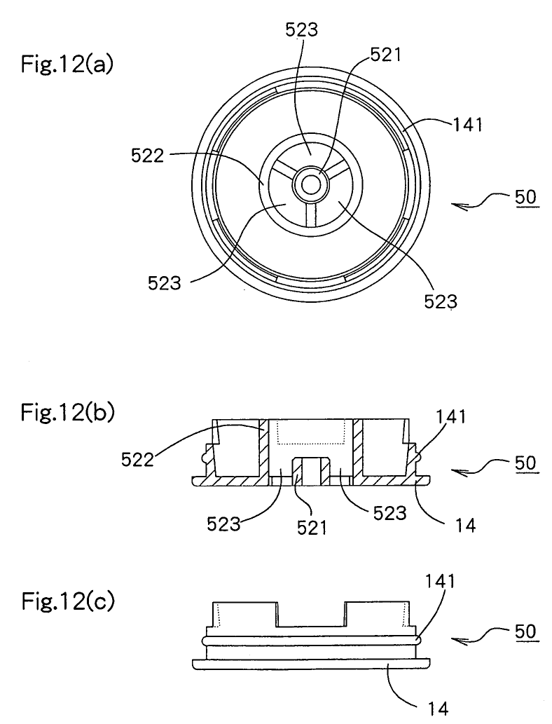

FIGS. 11(a)-(d) are explanatory views showing an inflow valve member 51 comprising the inflow valve mechanism 50 according to Embodiment 2 of the present invention; FIGS. 12(a)-(c) are explanatory views showing a bottom portion 14 of a fluid-storing portion 10, which is formed as one with an inflow valve seat member 52 comprising the inflow valve mechanism 50 according to Embodiment 2 of the present invention. FIGS. 11(a)-(d) are a plan view, lateral cross section, lateral view, and bottom view, respectively, showing the inflow valve member 51; FIGS. 12(a)-(c) are a plan view, lateral cross section and lateral view, respectively, showing the bottom portion 14.

The inflow valve mechanism 50 comprises the outflow valve member 51 possessing a valve body portion 511, and the bottom portion 11 being formed as one with the inflow valve seat member 52 possessing a valve member supporting portion 421 supporting the inflow valve member 51.

The inflow valve member 51 comprises a flexible valve body portion 511 radiating from the central portion, and a supporting portion 512 extending from the valve body portion 511.

The inflow valve seat member 52 being formed as one with the bottom portion 11 comprises a valve member supporting portion 521 for supporting the inflow valve member 51 and a valve seat portion 522 having a shape corresponding to the valve body portion 511; and around the valve member supporting portion 521, three opening portions 523 for letting outer-air pass through are formed.

Although the inflow valve seat member 51 is adapted to have three opening portions 523 to be formed, the number of the opening portions is not limited to three. However, in order to effectively prevent unbalanced inflow of outer-air, it is preferable to dispose them equally around the valve member supporting portion 521.

Additionally, the bottom portion 14 comprises a joined portion 141 being joined with the lower end 121 of the fluid-storing portion 10.

When this inflow valve mechanism 50 comprising the inflow valve member 51 and the inflow valve seat member 52 is compressed from downward, the valve body portion 511 travels to a position in which it separates from the valve seat portion 522 in the inflow valve seat member 52 from a position in which it contacts the valve seat portion 522 by the flexibility of the valve body portion 511 in the inflow valve member 51. This enables outer-air to pass through the inflow valve mechanism 50. When upward and downward pressures being applied to the inflow valve mechanism 50 become approximately equal by outer-air having flowed in, the valve body portion 511 travels to a position in which it contacts the valve seat portion 522 in the inflow valve seat member 52 from a position in which it separates from the valve seat portion 522 by the flexibility of the valve body portion 511 in the inflow valve member 51. This makes outer-air impossible to pass through the inflow valve mechanism 50.

When this fluid-storing container according to Embodiment 2 is used, when inside the fluid-storing container is pressurized with the fluid-storing portion 10 being pressed as shown in FIG. 9, a fluid stored inside it and the outflow valve mechanism 40 are compressed from downward. When the outflow valve mechanism 40 is compressed from downward, the edge portion of the valve body portion 411 travels to a position in which it separates from the valve seat portion 421 in the outflow valve seat member 42 from a position in which it contacts the valve seat portion 421 by the flexibility of the valve body portion 411 in the outflow valve member 41. By this, the fluid passes through the outflow valve mechanism 40 and then flows out to outside the fluid-storing container.

As an amount of the fluid reduces with the fluid having flowed out, a piston 20 ascends inside a cylinder portion 12; and the lower portion side of the fluid-storing portion 10 being partitioned by the piston 20 is depressurized. Consequently, the inflow valve mechanism 50 is compressed from downward. When the inflow valve mechanism 50 is compressed from downward, the valve body portion 511 travels to a position in which it separates from the valve seat portion 522 in the inflow valve seat member 52 from a position in which it contacts the valve seat portion 522 by the flexibility of the valve body portion 511 in the inflow valve member 51. By this, outer-air passes through the inflow valve mechanism 50 and then flows into the fluid-storing portion of the container.

When the pressure applied to the fluid-storing portion 10 is removed and the compression to the outflow valve mechanism 40 from downward is removed, the edge portion of the valve body portion 411 travels to a position in which it contacts the valve seat portion 421 in the outflow valve seat member 42 from a position in which it separates from the valve seat portion 421 by the flexibility of the valve body portion 411 in the outflow valve member 41. This makes the fluid impossible to pass through the outflow valve mechanism 40.

When upward and downward pressures being applied to the inflow valve mechanism 50 become approximately equal by outer-air having flowed in, the valve body portion 511 travels to a position in which it contacts the valve seat portion 522 in the inflow valve seat member 52 from a position in which it separates from the valve seat portion 522 by the flexibility of the valve body portion 511 in the inflow valve member 51. This makes outer-air impossible to pass through the inflow valve mechanism 50.

Embodiment 3 of the present invention is described in detail below with reference to drawings attached.

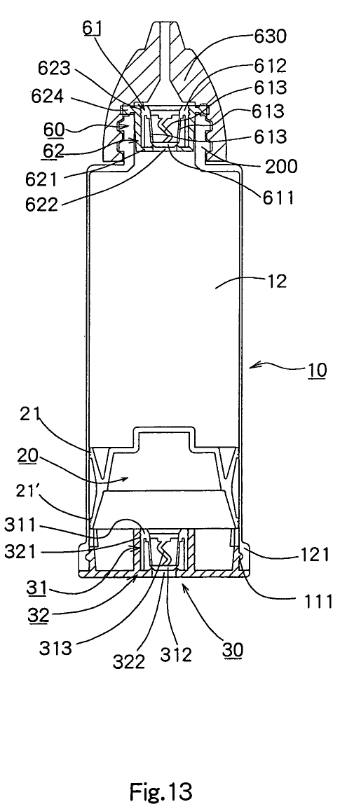

FIG. 13 is a lateral cross section of the fluid-storing container according to Embodiment 3 of the present invention.

Whereas the fluid-storing container according to Embodiment 1 comprises the outflow valve mechanism 40, the fluid-storing container according to Embodiment 3 comprises an outflow valve mechanism 60 in place of the outflow valve mechanism 40.

The outflow valve mechanism 60 comprises an outflow valve member 61 possessing a valve body portion 611, and an outflow valve seat member 62 possessing a valve seat portion 621 supporting the outflow valve member 61.

The outflow valve member 61 has the valve body portion 611, an annular supporting portion 612, and four flexible coupling portions 613 coupling the valve body portion 611 and the supporting portion 612. These respective coupling portions have a pair of flexions.

The outflow valve seat member 62 comprises a nearly-tubular valve seat portion 621 at the bottom of which an opening portion 622 having a shape corresponding to the valve body portion 611 in the outflow valve member 61 is formed, a joined portion supporting and being joined with the inflow valve member 61, and an engaging portion 623 engaging with an opening portion 13 in a fluid-storing portion 10.

When this outflow valve mechanism 60 comprising the outflow valve member 61 and the outflow valve seat member 62 is compressed from downward, the valve body portion 611 travels to a position in which it opens the opening portion 622 in the outflow valve seat member 62 from a position in which it closes the opening portion 622 by the flexibility of the coupling portions 613 in the outflow valve member 61. This enables a fluid to pass through the outflow valve mechanism 60. When the compression to the outflow valve mechanism 60 from downward is removed, the valve body portion 611 travels to the position in which it closes the opening portion 622 in the outflow valve seat member 62 from the position in which it opens the opening portion 622 by the flexibility of the coupling portions 613 in the outflow valve member 61. This makes the fluid impossible to pass through the outflow valve mechanism 60.

Using the fluid-storing container according to Embodiment 3, it becomes possible to store the fluid liquidtightly and to use the container repeatedly while its configuration is simple.

Additionally, although the fluid-storing container according to Embodiment 3 comprises an inflow valve mechanism 30 similarly to the fluid-storing container according to Embodiment 1, it can also comprise an inflow valve mechanism 50 which the fluid-storing container according to Embodiment 2 comprises in place of the inflow valve mechanism 30.

It is preferable that the above-mentioned inflow valve mechanisms 30 & 50 and the outflow valve mechanisms 40 & 60 are constituted by, for example, a resin such as polyethylene and polypropylene, rubber composite such as silicon rubber, or a mixture of the foregoing. It is preferable that the cylinder portion 12 in the fluid-storing portion 10 is constituted by a material having reasonable elastic resilience.

The present invention includes the above mentioned embodiments and other various embodiments including the following:

1) A fluid-storing container is characterized by possessing a tubular flexible fluid-storing portion with a bottom, inside which functions as a cylinder; a piston capable of traveling inside the fluid-storing portion in the axial direction of the cylinder; an inflow valve mechanism being provided at the bottom of the fluid-storing portion and enabling outer-air to flow into the fluid-storing portion from the outside; and an outflow valve mechanism being provided in an opening portion of the fluid-storing portion and enabling a fluid to flow out from the fluid-storing portion to the outside.

2) The fluid-storing container according to Item 1, wherein the outflow valve mechanism comprises a outflow valve member possessing a flexible valve body portion radiating from the central portion, a first supporting portion extending from the central portion of the valve body portion, and a second supporting portion extending from the central portion of the valve body portion and being provided on the opposite side of the first supporting portion; a supporting member possessing an engaging portion engaging with the opening portion in the fluid-storing portion, flow paths being formed so as to enable a fluid to pass through between inside and outside the fluid-storing portion, and multiple ribs supporting the first portion in the outflow valve member; and an inflow valve member possessing a valve seat portion having a shape corresponding to an edge portion of the valve body portion in the outflow valve member, an engaging portion engaging with the opening portion in the fluid-storing portion, an opening portion through which the fluid can pass through between inside and outside the fluid-storing portion, and multiple ribs being formed inside the opening portion and supporting the second supporting portion in the outflow valve member.

3) The fluid-storing container according to Item 2, wherein the outflow valve member is provided with the second supporting portion being positioned more to the outer side of the fluid-storing portion than the first supporting portion being positioned.

4) The fluid-storing container according to Item 2 or 3, wherein the flow paths in the supporting member are formed among the multiple ribs.

5) The fluid-storing container according to any one of Items 2 to 4, wherein the first supporting portion is movably supported relative to the ribs in the supporting member and the second supporting portion is movably supported relative to the ribs in the outflow valve seat member.

6) The fluid-storing container according to any one of Items 1 to 5, wherein the inflow valve mechanism comprises a nearly-tubular inflow valve seat member at the bottom of which a circular opening portion for fluid inflow is formed; and an inflow valve member possessing an annular supporting portion being disposed inside the inflow valve seat member, a valve body portion having a shape corresponding to the opening portion of the inflow valve seat member and multiple flexible coupling portions coupling the supporting portion and the valve body portion.

According to the embodiments described in Items 1 to 3 and Item 6, because it comprises a tubular flexible fluid-storing portion with a bottom, inside which functions as a cylinder, a piston capable of traveling inside the fluid-storing portion in the axial direction of the cylinder, an inflow valve mechanism being provided at the bottom of the fluid-storing portion and enabling outer-air to flow into the fluid-storing portion from the outside, and an outflow valve mechanism being provided in an opening portion of the fluid-storing portion and enabling a fluid to flow out from the fluid-storing portion to the outside, it becomes possible to store the fluid liquidtightly and to use it repeatedly while its configuration is simple.

According to the embodiment described in Item 4, because the flow paths in the supporting member are formed among the multiple ribs, it becomes possible to make the configuration simpler.

According to the embodiment described in Item 5, because the first supporting portion is movably supported relative to the ribs in the supporting member and the second supporting portion is movably supported relative to the ribs in the outflow valve seat member, it becomes possible to bring a fluid having flowed out in the vicinity of a discharge opening back in, thereby enabling to suppress fluid accumulation in the vicinity of the discharge opening.

Further, although the foregoing embodiments are preferable, the following modifications can be applied to any of the foregoing embodiments:

Instead of the valve mechanism in the preferred embodiments, the inflow or outflow valve mechanism can be of any type such as those disclosed in U.S. Pat. No. 6,688,495 to Masatoshi Masuda (the inventor of the present application), the disclosure of which is herein incorporated by reference in its entirety.

The opening portion of the inflow valve seat member may have a diameter of round 10 mm (e.g., 5 mm to 15 mm), so that airtightness can effectively be accomplished. If the diameter is too large, it becomes more difficult to maintain airtightness. On the other hand, if the diameter is too small, it becomes more difficult to release the inside pressure when refilling the fluid-storing portion with another fluid from the neck portion. In order to release the inside pressure, the inflow valve body portion can be pushed by a finger, for example.

In at least one of the preferred embodiments, the fluid-storing portion, the inflow valve mechanism, the outflow valve mechanism, and the piston are arranged co-axially. However, the co-axial configuration is not required. In an embodiment, the neck portion of the fluid-storing portion is angled and the outflow valve mechanism is attached to the neck portion. In another embodiment, although the above elements are co-axially arranged, the tip of the nozzle member (or the tip of the outflow valve seat member) need not be arranged co-axially. The angle of the nozzle member (i.e., the direction of dispensing fluid from the nozzle member) can be designed as desired.

The fluid-storing portion may but need not be cylindrical. A cylindrical shape is preferable because the piston can slide smoothly without suffering fluid-tightness. However, the cross section of the fluid-storing portion can be elliptical, oval, corner-rounded quadrilateral, corner-rounded polygonal, or of any other shape as long as fluid-tightness can be maintained. Similarly, the inflow and/or outflow valve mechanism can be of any suitable shape.

The fluid-storing portion is compressible and shape-restorable, so that the fluid can be dispensed by pushing an outer surface of the portion without permanently reshaping the fluid-storing portion. In this way, the fluid-storing portion can be repeatedly used. The fluid-storing portion can be constituted by a resin material same as or similar to those used for the inflow valve mechanisms and the outflow valve mechanisms; e.g., a resin such as polyethylene and polypropylene, rubber composite such as silicon rubber, or a mixture of the foregoing (all of the components of the container can be constituted by these materials). In order to impart reasonable elastic resilience to the fluid-storing portion, the thickness may be in the range of about 0.5 mm to about 2 mm.

More fluid-tightness may be required to the inflow valve mechanism than the outflow valve mechanism. When the valve mechanism is of a valve body displacement type such as the inflow valve mechanism 30, an annular projection formed along the opening is effective to accomplish fluid-tightness.

In at least one of the preferred embodiments, the piston has a structure as if two cups are attached at their bottoms wherein the attached portion is narrower than the upper periphery and the lower periphery. The upper fluid-tight portion and the lower fluid-tight portion are arranged at the upper periphery and the lower periphery, respectively. This configuration is effective to fluid-tightly slide the piston regardless of where pressure is applied to dispense the fluid (this is also because of fluid-tightness of the inflow and outflow valve mechanisms). However, any other configurations can be used as long as fluid-tight portions are urged outward against the inner surface of the fluid-storing portion and are stably slidable. For example, a piston can be constituted by multiple discs (e.g., an integer of 2-10) made of a resilient material and stacked in the axial direction, wherein the outer diameter of the disc is larger than the inner diameter of the fluid-storing portion.

In at least one of the preferred embodiments, the valve body member of the outflow valve mechanism is an elastic deformation type such as the valve body member 41, which is slightly movable in the axial direction when pressure is applied and released, so that leakage of the fluid from the nozzle portion can effectively be prevented. However, such slight movement is not required in another embodiment. The valve body member of the outflow valve mechanism can be of the type same as the valve body member of the inflow valve mechanism 50.

As described above, typically the container comprises no pump, although the container comprises a piston. The use of a piston without a pump can be accomplished as described above. Although the container is of a compression type without a pump, the container is refillable. When refilling the container, a pump may be used. Further, by replacing the outflow valve mechanism and the nozzle member with a pump mechanism and a nozzle, the remaining structures of the container can be used as a pump type dispensing container.

The present application claims priority to Japanese Patent Application No. 2004-043842, filed Feb. 20, 2004, the disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

1. A fluid-storing and -dispensing container comprising:
a tubular fluid-storing portion which is compressible and shape-restorable;
an inflow valve mechanism provided at a lower end of the fluid-storing portion, said inflow valve mechanism being a one-way valve permitting outer-air to flow therethrough into the fluid-storing portion;
an outflow valve mechanism provided at an upper end of the fluid-storing portion, said outflow valve mechanism being a one-way valve for dispensing therethrough a fluid stored in the fluid-storing portion; and
a piston capable of moving inside the fluid-storing portion in its axial direction between the lower end the upper end, said piston constituting a bottom of the tubular flexible fluid-storing portion, wherein the fluid is stored in the fluid-storing portion between the piston and the upper end and dispensed through the outflow valve mechanism when the fluid-storing portion is compressed inward.

2. The fluid-storing and -dispensing container according to claim 1, wherein the piston comprises an upper liquidtight portion, a lower liquidtight portion, and a narrowed portion between the upper and lower liquidtight portions.

3. The fluid-storing and -dispensing container according to claim 1, wherein a neck portion is provided at the upper end of the fluid-storing portion, and the outflow valve mechanism is attached to the neck portion.

4. The fluid-storing and -dispensing container according to claim 3, wherein the outflow valve mechanism comprises: an outflow valve member and an outflow valve seat member, which are co-axially provided.

5. The fluid-storing and -dispensing container according to claim 4, wherein the outflow valve member comprises a flexible valve body portion extending radically from a central portion, wherein the flexible valve body portion has a peripheral edge which is in contact with an inner surface portion of the outflow valve seat member to close the outflow valve mechanism and which is apart from the inner surface portion of the outflow valve seat member to open the outflow valve mechanism when the fluid stored in the fluid-storing portion is pressurized.

6. The fluid-storing and -dispensing container according to claim 5, wherein the outflow valve member further comprises a supporting portion extending downward from the central portion, and the outflow valve mechanism further comprises a supporting member which supports the supporting portion of the outflow valve member and which is attached to the neck portion.

7. The fluid-storing and -dispensing container according to claim 6, wherein the supporting portion is a first supporting portion, and the outflow valve member further comprises a second supporting portion extending upward from the central portion.

8. The fluid-storing and -dispensing container according to claim 7, wherein the outflow valve seat member comprises (i) an opening portion through which the fluid is dispensed, said opening portion being provided above the inner surface portion; (ii) multiple ribs formed inside the opening portion and supporting the second supporting portion; and (iii) an engaging portion which engages with the neck portion and secures the supporting member to the neck portion.

9. The fluid-storing and -dispensing container according to claim 7, wherein the supporting member comprises multiple ribs supporting the first supporting portion of the outflow valve member, wherein spaces between the multiple ribs constitute a fluid path through which the fluid passes.

10. The fluid-storing and -dispensing container according to claim 9, wherein the first supporting portion is movable in its axial direction in the ribs of the supporting member, and the second supporting portion is movable in its axial direction in the ribs of the outflow valve seat member.

11. The fluid-storing and -dispensing container according to claim 4, wherein the outflow valve member comprises:
a valve body portion;
a supporting portion for supporting the valve body portion, which is coupled to the outflow valve seat member; and
a flexible connecting portion connecting the valve body portion and the supporting portion.

12. The fluid-storing and -dispensing container according to claim 11, wherein the flexible connecting portion is constituted by multiple connecters attached to a peripheral edge of the valve body portion.

13. The fluid-storing and -dispensing container according to claim 11, wherein the outflow valve seat member comprises (i) an opening portion which is closed when the valve body portion is in contact with the opening portion and which is open when the valve body portion moves away from the opening portion as the fluid stored in the fluid-storing portion is pressurized and passes through the opening portion; and (ii) an engaging portion which engages with the neck portion.

14. The fluid-storing and -dispensing container according to claim 13, further comprising a nozzle member which engages with the neck portion and secures the engaging portion of the outflow valve seat member.

15. The fluid-storing and -dispensing container according to claim 1, wherein the inflow valve mechanism comprises: an inflow valve member and an inflow valve seat member, which are co-axially provided.

16. The fluid-storing and -dispensing container according to claim 15, wherein the inflow valve member comprises:
a valve body portion;
a supporting portion for supporting the valve body portion, which is coupled to the inflow valve seat member; and
a flexible connecting portion connecting the valve body portion and the supporting portion.

17. The fluid-storing and -dispensing container according to claim 16, wherein the flexible connecting portion is constituted by multiple connecters attached to a peripheral edge of the valve body portion.

18. The fluid-storing and -dispensing container according to claim 16, wherein the inflow valve seat member comprises (i) an opening portion which is closed when the valve body portion is in contact with the opening portion and which is open when the valve body portion moves away from the opening portion as a pressure between the piston and the inflow valve mechanism is lower than the outside, whereby outer-air passes through the opening portion; (ii) an engaging portion which engages with the supporting portion of the inflow valve member; and (iii) a bottom portion with a jointed portion, wherein the opening portion is formed in the bottom portion, and the jointed portion is jointed to the lower end of the fluid-storing portion.

19. The fluid-storing and -dispensing container according to claim 15, wherein the inflow valve member comprises (i) a flexible valve body portion extending radically from a central portion, wherein the flexible valve body portion has a peripheral edge which is in contact with an inner surface portion of the inflow valve seat member to close the inflow valve mechanism and which is apart from the inner surface portion of the inflow valve seat member to open the inflow valve mechanism when a pressure between the piston and the inflow valve mechanism is lower than the outside, whereby outer-air passes through the inflow valve mechanism; and (ii) a supporting member which extends downward from the central portion, said supporting member being attached to the inflow valve seat mechanism.

20. The fluid-storing and -dispensing container according to claim 19, wherein the inflow valve seat member comprises (i) a valve member supporting portion to which the supporting member of the inflow valve member is attached; (ii) an opening portion through which outer-air passes, said opening portion being formed around the valve member supporting portion and being surrounded by the inner surface portion; and (iii) a bottom portion with a jointed portion, wherein the opening portion is formed in the bottom portion, and the jointed portion is jointed to the lower end of the fluid-storing portion.

21. The fluid-storing and -dispensing container according to claim 1, which is reusable wherein the outflow valve mechanism is detachably provided at the upper end of the fluid-storing portion, and after the fluid is dispensed, the fluid-storing portion is refilled with another fluid through the upper end of the fluid-storing portion.
